(19) United States
(12) Patent Application Publication
(10) Pub. No.: US 2002/0116095 A1
(43) Pub. Date: Aug. 22, 2002

(54) Method for verifying the integrity of the bus prior to pedal adjustment

(76) Inventors: Timothy A. Miller, Waterford, MI (US); Patrick D. Dean, Armada, MI (US); David F. Wagner, Rochester, MI (US); James L. Carlson, Madison Heights, MI (US); Gary F. Kajdasz, Commerce Township, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 09/974,673

(22) Filed: Oct. 10, 2001

Related U.S. Application Data
(60) Provisional application No. 60/239,591, filed on Oct. 11, 2000.

(51) Int. Cl. G06F 7/00

(52) U.S. Cl. 701/1; 701/29

(57) ABSTRACT

A system of verifying the integrity of a data bus for a motor vehicle. The system includes a first module for acknowledging a manual input signal initiated by the motor vehicle occupant. The first module has active and inactive mode. The first module is in inactive mode during its normal condition, and it is activated upon receiving the input signal. The first module transmits a triggering signal to a second module over the data bus. The second module also has active and inactive modes, and it is in inactive mode during the normal condition. The second module is activated upon receiving the triggering signal from the first module, and subsequently transmits a signal back to the first module. The integrity of data bus is verified by the data transfer between first and second modules over the data bus within a predetermined time period.

### CROSS-REFERENCE TO RELATED APPLICATIONS

This application claims the benefit of U.S. Provisional Patent Application Serial No. 60/239,591, filed on Oct. 11, 2000.

### BACKGROUND OF THE INVENTION

1. Field of the Invention

The present invention relates generally to a system for pedal adjustment for motor vehicles, and more particularly, to apparatuses and methods for verifying the integrity of the data bus prior to pedal adjustment for motor vehicles.

2. Description of the Related Art

With increasing sophistication of motor vehicles, several electronic control units (ECU) are used to control different systems of the vehicle. Such ECUs monitor various control inputs and operational conditions of various systems. For example, a engine control unit may monitor engine speed, torque, pedal depression and other operating parameters of the engine to optimize the performance of the engine.

The various ECUs are interconnected by a data bus so that information may be interchanged between them. The data bus enables the ECUs to function in an integrated manner. As the number of systems that are controlled by the ECUs increases, it has become critical that the data bus does not malfunction since it may affect the correct operation of the vehicle ECUs to which it provides information.

Verification of the integrity of the data bus has heretofore been necessary to confirm that communication between various vehicle systems and their control modules is provided to optimize the performance of the vehicle. Conventionally, the integrity of the data bus is verified upon receiving all of the identifying messages. This traditional method requires more time since the control module has to wait for all of the identifying messages from various vehicle systems to which it is interconnected. In addition, this method could be performed only when the vehicle engine is running. Thus, it is difficult to check the performance of vehicle systems that are active in a vehicle key-off condition.

Therefore, it would be desirable to provide an apparatus or method to verify the integrity of the data bus when the vehicle is in a key-off condition. Accordingly, the performance of vehicle systems, which are activated in the key-off condition, can also be optimized. It would also be highly desirable to provide an apparatus or method to verify the integrity of data bus that does not require waiting for the identifying messages from all of systems connected to the data bus, thus minimizing the data transfer time and the current draw from the vehicle's battery.

### SUMMARY OF THE INVENTION

This invention is directed to a system and method of verifying the integrity of a data bus for a motor vehicle. More particularly, this invention is directed to a system and method of verifying the integrity of a data bus for a motor vehicle using at least two vehicle modules that have active and inactive modes when the vehicle is in key-off condition.

The system includes a first module to acknowledge a manual input signal initiated by the motor vehicle occupant. The first module has an active and an inactive mode. The first module is in an inactive mode during its normal key-off condition. The first module is activated upon receipt of an input signal. The first module transmits a triggering signal to a second module over the data bus. The second module communicates bi-directionally with the first module. The second module also has an active and an inactive mode. The second module is in an inactive mode during the normal condition. The second module is activated upon receipt of a triggering signal from the first module. The second module subsequently transmits a signal back to the first module. The data bus provides a bi-directional communication between the first and second modules. The integrity of data bus is verified by the data transfer between the first and second modules over the data bus within a predetermined time period.

The present invention is applicable for motor vehicles that includes at least two modules with an active and an inactive mode when the vehicle is in key-off condition. The present invention, thus enables the vehicle to check the integrity of the data bus even when the vehicle is in a key-off condition. In addition, since these two modules are active only when the manual interrupt signal is received, the current draw from the battery of the motor vehicle is kept to a minimum.

Further areas of applicability of the present invention will become apparent from the detailed description. It should be understood however that the detailed description and specific examples, while indicating preferred embodiments of the invention, are intended for purposes of illustration only, since various changes and modifications within the spirit and scope of the invention will become apparent to those skilled in the art.

### BRIEF DESCRIPTION OF THE DRAWINGS

The present invention will become more fully understood from the detailed description and the accompanying drawings, wherein:

FIG. 1 is a perspective view depicting the adjustable pedal assembly system of the presently preferred embodiment of the invention;

FIG. 2 is a block diagram depicting the adjustable pedal assembly system of the presently preferred embodiment of the invention;

FIG. 3 is a flow chart depicting the acquisition of a required adjustment of the pedal assembly of the presently preferred embodiment of the invention;

FIG. 4 is a flow chart depicting the method of verifying the integrity of data bus of the presently preferred embodiment of the invention;

FIG. 5 is a table describing the data bus message communication during different ignition states; and

FIG. 6 is a table describing fault condition lockouts according to the presently preferred embodiment of the invention.

### DETAILED DESCRIPTION OF THE PREFERRED EMBODIMENT

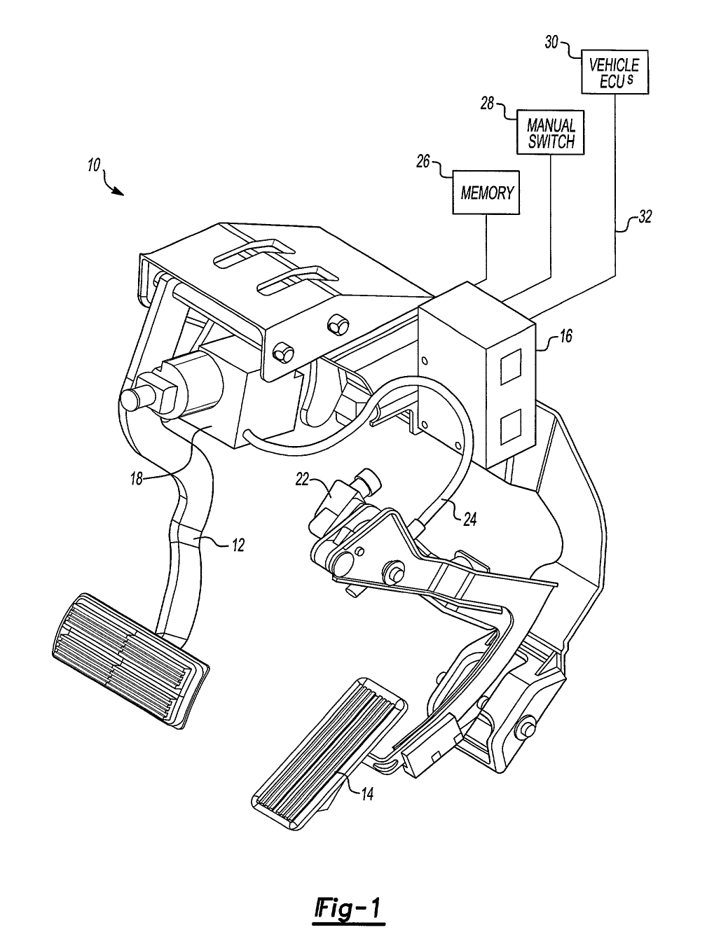

Referring to FIG. 1, an adjustable pedal module system (APMS) 10 for a motor vehicle is illustrated in accordance with the teachings of the present invention. The APMS 10 includes a brake pedal assembly 12, an accelerator pedal assembly 14, an adjustable pedal module (APM) 16, and supporting electrical circuits (not shown). The APM 16 controls the pedal assemblies 12 and 14 and communicates with other vehicle electronic control units (ECUs) 30. The APM 16 may receive a manual interrupt input from either a manual switch 28 or from memory 26. The APM 16 is connected to the ECUs via a data bus 32. Movements of the accelerator pedal assembly 14 are monitored by a movement sensor 22. The movement sensor 22 is connected to a motor module 18 through a cable 24.

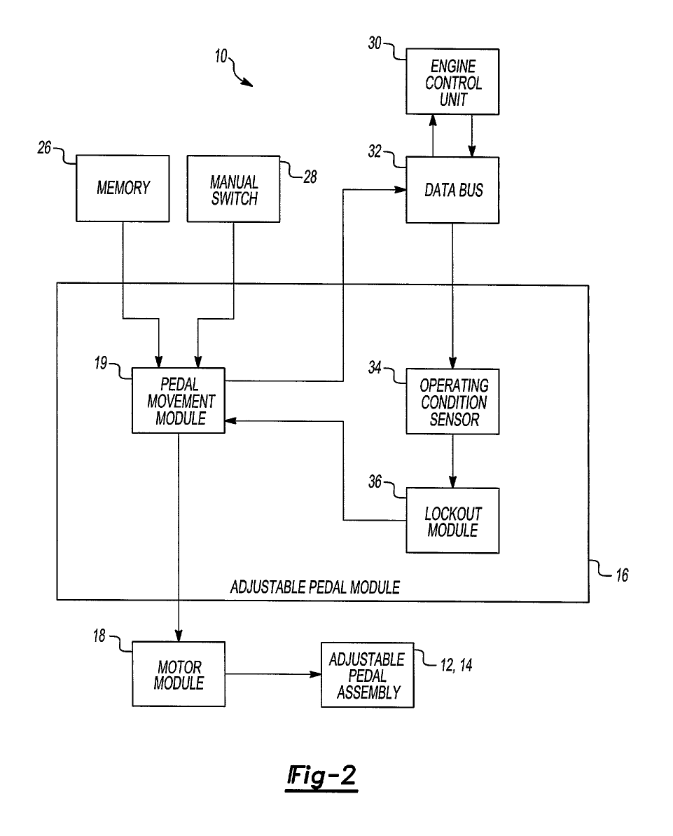

FIG. 2 of the drawings illustrates the preferred embodiment of the APM 16 in greater detail. The APM 16 further contains a pedal movement module 19, an operating condition sensor 34, and a lockout module 36. The pedal movement module 19 receives manual interrupt inputs from the manual switch 28 and memory 26. The pedal movement module 19 communicates with the ECUs 30 through the data bus 32. The operating condition sensor 34 receives identifying messages from the various modules of the motor vehicle. The operating conditional messages are collected in the operating condition sensor 34 and sent to the lockout module 36. The lockout module 36 determines the existence of any lockout conditions based upon the identifying messages received by the operating condition sensor 34. If any of lockout conditions are detected, the pedal movement module 19 of the APM 16 disables the adjustment of the pedal assemblies 12 and 14. If no lockout conditions are detected, the pedal movement module 19 adjusts the pedal assemblies 12 and 14 to a desired position.

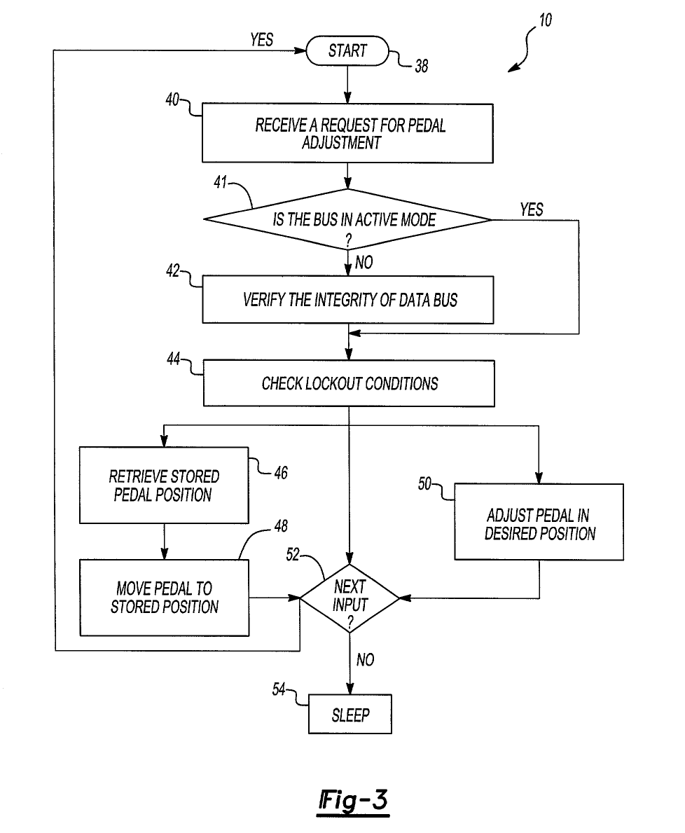

With further reference to FIG. 3 of the drawings, a process for adjusting the pedal assemblies 12 and 14 in accordance with the teachings of the present invention is illustrated. The APMS 10 receives an input at step 40. The input signal may be from either the manual switch 28, which is pressed by a vehicle occupant, or memory 26. The memory 26 retains at least two different pedal positions. Upon a request for adjustment of the pedal assembly 12 and 14 by the vehicle occupant, the input signal is sent to the pedal movement module 19 of the APM 16.

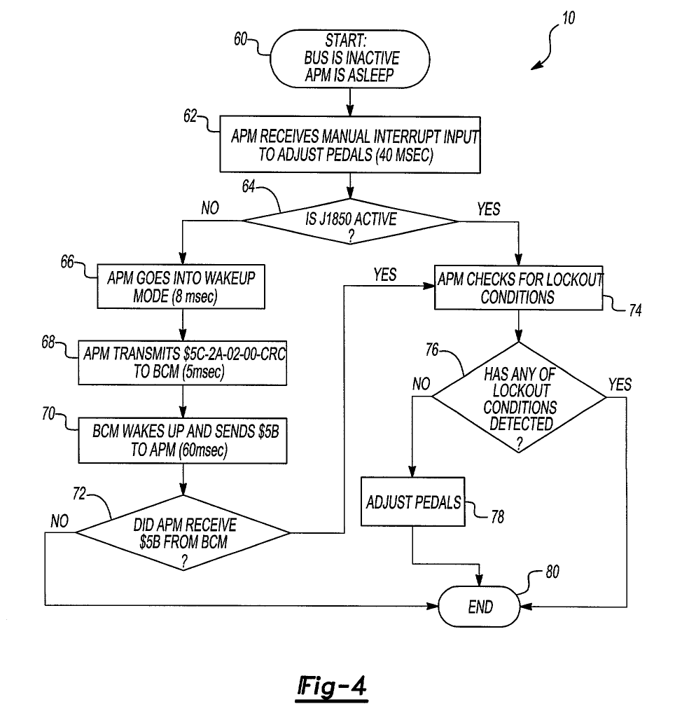

The pedal movement module 19 of the APM 16 controls the movement of both the brake assembly 12 and the accelerator assembly 14. When the pedal movement module 19 acknowledges an input signal, the APM 16 determines whether the data bus 32 is in an active mode, step 41. If the data bus 32 is in an active mode, the APM 16 proceeds on to checking lockout conditions, step 44. On the other hand, if the data bus 32 is in an inactive mode, the integrity of data bus 32 is verified, step 42. More particularly, at step 42, the APMS 10 determines if the data bus 32 is capable of providing bi-directional communication between the ECUs 30 and the APM 16. The step of verifying the integrity of data bus 32 will be described below in greater detail with reference to FIG. 4.

In the preferred embodiment, a SAE J1850 bus is used as the data bus 32 for providing bi-directional communication between the APM 16 and the ECUs 30. However, it should be understood that any data bus, such as a Controller Area Network (CAN) data bus, can also be used so long as bi-directional communication is supported between vehicle ECUs.

Once the integrity of the data bus 32 has been established, other ECUs place lockout information on the bus. After the integrity of data bus 32 is verified, the APM 16 determines whether lockout conditions exist, step 44. The pedal movement module 19 interfaces with the vehicle ECUs 30 via data bus 32 in order to monitor operating conditions of the vehicle.

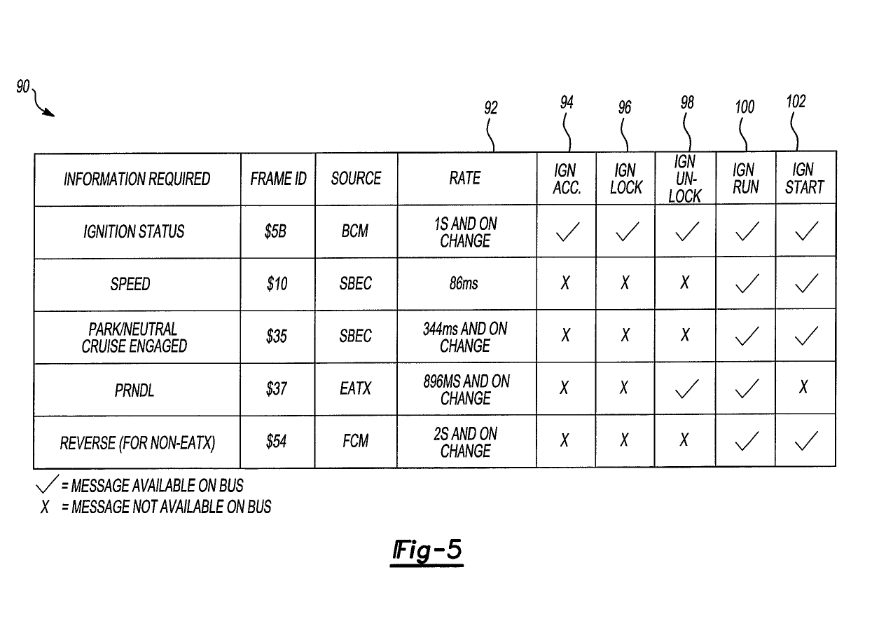

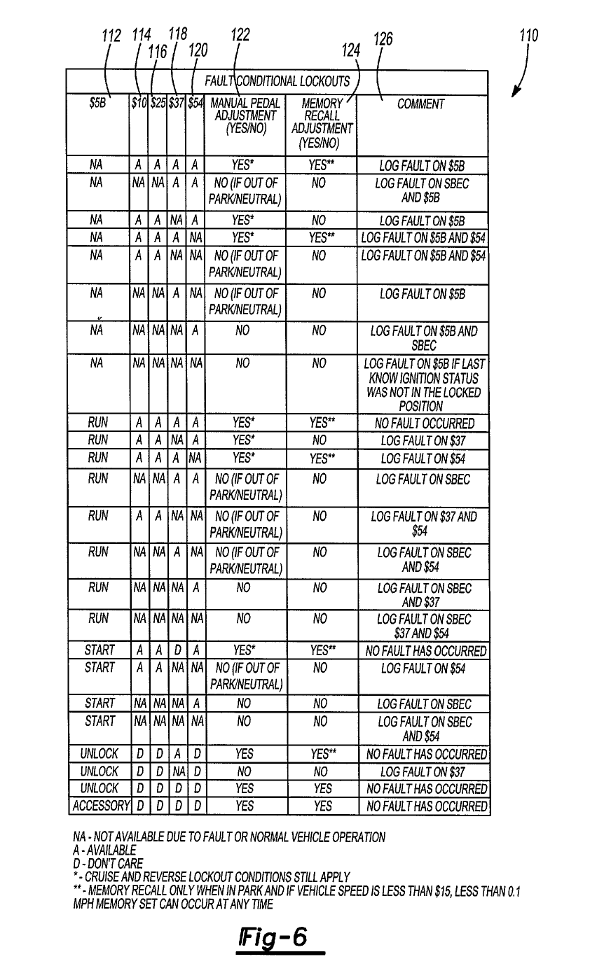

The signals from the ECUs 30 are transmitted to the lockout module 36. The lockout module 36 monitors the signals to determine whether any lockout conditions exist. What constitutes a lockout condition will be more fully described below with reference to FIGS. 5 and 6.

The presence of lockout conditions determines whether to adjust the pedal assemblies 12 and 14 to a desired position. If any of the lockout conditions are detected, the APMS 10 does not adjust the pedal assemblies 12 and 14, but instead terminates the process, step 52. If no lockout conditions are found, the pedal assemblies 12 and 14 are adjusted to the desired position, step 50. If the input signal is received from the memory 26 and no lockout conditions are identified, the APMS 10 retrieves the desired pedal position from memory 26. Subsequently, the APMS 10 moves the pedal assemblies 12 and 14 to the stored position, step 48. At step 52, the APMS 10 waits for the next input from the vehicle occupant, and enters a sleeping mode, step 54.

With reference to FIG. 4, a more detailed flowchart of the APMS 10 is illustrated. At step 60, the data bus is in an inactive mode and the APM 16 is in a sleeping mode. As mentioned above, the APMS 10 receives a manual interrupt input signal from a manual switch 28 to adjust the pedal assemblies 12 and 14, step 62. Upon receiving the manual interrupt input signal, the APM 16 debounces and decodes the input signal. The maximum rate at which the APMS 10 receives the input signal and adjusts the pedal assemblies 12 and 14 is forty msec.

At step 64, the APMS 10 monitors the SAE J1850 data bus 32 for an active mode. If the SAE J1850 is active, the APM 16 of APMS 10 checks for lockout conditions, step 74. The following table 1 shows the lockout conditions for the APMS 10.

TABLE I

| Vehicle conditions | Lockout |
|---|---|
| Transmission in Reverse Gear | The switches and memory recall shall |
| | lockout |
| Cruise Control engaged (speed set) | The switches and memory recall shall |
| | lockout |
| Transmission in Neutral, Drive, or | Only memory recall shall lockout |
| Low gear or speed >0 | |

The APMS 10 disables the adjustable pedal feature under certain conditions. In the preferred embodiment of present invention, the APMS 10 has different lockout conditions depending on the source of the manual interrupt input signal. If the input signal is from the memory 26, the APMS 10 will only adjust the pedal assemblies 12 and 14 when the transmission of vehicle is in Park. If the input signal is from the manual switch 28, the pedal assemblies 12 and 14 are locked out only when the transmission is in Reverse or when cruise control is engaged.

In order to determine if the vehicle is under any of the lockout conditions, the pedal movement module 18 of the APM 16 monitors signals from various ECUs 30 via the SAE J1850 data bus 32. The ECUs 30 periodically transmit signals indicative of operating conditions of the vehicle. Tables 2 and 3 shows bus messages used to determine lockout conditions and a description of each bus message.

TABLE 2

| Frame | | | |
|---|---|---|---|
| ID # | Description | Source | Rate |
| $5B | Ignition Switch | Body controller module | 1 Sec. And on |
| | Status | (BCM) | change |
| $10 | Engine RPM, | Engine Controller | 86 msec. |
| | Speed, and MAP | Module (SBEC/DEC) | |
| $35 | Misc. Engine | Engine Controller | 344 msec. and |
| | Status | Module (SBEC/DEC) | on change |
| $37 | PRNDL Display | Transmission | 896 msec. and |
| | | Controller Module | on change |
| | | (EATX) | |
| $54 | Warning Data | Front Control Module | 2 sec. And on |
| | | (FCM) | change |

TABLE 3

| Frame ID # | Description |
|---|---|
| $5B | The ARM 16 shall receive the $5B bus message to detect |
| | the ignition switch bus status for logging communication |
| | faults |
| $10 | Also, the APM 16 shall use the $10 bus message to monitor |
| | the speed during memory recall and determine if the feature |
| | needs to be locked out. |
| $35 | The APM 16 shall receive the $35 bus message to detect if |
| | the cruise control is engaged or detected if the vehicle is in |
| | Park/Neutral and determine if the feature needs to be locked |
| | out. |
| $37 | The ARM 16 shall receive $37 bus message to detect if the |
| | vehicle is in Park, Reverse, Neutral, Drive, or Low Gear. |
| $54 | The APM 16 shall receive the $54 bus message to detect if |
| | the vehicle is in Reverse gear and determine if the feature |
| | needs to be locked out. |

As briefly mentioned above, the APM 16 determines if lockout conditions exist before the APM 16 adjusts the pedal assemblies 12 and 14. Frame $35 shows when cruise control is engaged or if the transmission is in Park or Neutral. The APMS 10 locks out the pedal assemblies 12 and 14 when $35 message indicates that either cruise control is engaged and the vehicle transmission is in neither Park nor Neutral.

The bus message $37 indicates whether the vehicle transmission is in Park, Neutral, Drive, or Low. In bus message $37, the least three significant bits of a data byte may show if the transmission is in Reverse. The status of the vehicle transmission determines whether to lock out the pedal assemblies 12 and 14. For example, the vehicle transmission must be in Park for the pedal assemblies 12 and 14 to be adjusted when the input signal is transmitted from memory recall 26.

Bus message $37 is available only for vehicles with automatic transmissions. For vehicles with manual transmissions, bus message $37 is not available. This is because the manual transmission is not controlled by ECUs, but is controlled strictly mechanically. For vehicles with automatic transmissions, the APM 16 uses bus messages $35 and $54 to determine which gear the transmission of the vehicle is in. The bus message $35 is indicative of whether the transmission is in PARK or NEUTRAL, and the bus message $54 is used to check if the transmission is in REVERSE. Thus, the APM 16 determines whether the transmission of the vehicle is in DRIVE depending on bus messages $35 and $54 for automatic transmission vehicles only.

Referring back to FIG. 4, the APM 16 checks for lockout conditions in step 74 from operating conditions transmitted from the aforementioned bus messages. If conditional step 76 of the APMS 10 detecting any of the lockout conditions is satisfied, in other words if the data bus 32 is inactive, the APMS 10 does not adjust the pedal assemblies 12 and 14, and returns to stand-by mode, step 80. If the lockout conditions are not determined, likewise if the data bus 32 is inactive, the APMS 10 adjusts the pedal assemblies 12 and 14 to a desired position and returns to the stand-by mode, steps 78 and 80.

The APMS 10 will lockout manual or memory controls due to a diagnostic issues. Still with reference to FIG. 4 of the drawings, if it is determined that the J1850 data bus 32 is inactive at step 64, the APMS 10 verifies the integrity of the data bus 32. When the integrity of the data bus 32 is verified, the APMS 10 checks for an open circuit condition. Open circuit provides miscommunications, which, in turn, cause the APMS 10 to malfunction. For example, if an open circuit exists and the integrity of the bus 32 is not verified, the APM 16 is likely to determine that the bus is inactive, and the other modules are asleep. Operation of the APM 16 is then excluded because the data bus 32 does not respond to the lockout conditions due to an open circuit.

Therefore, in this present invention, the APMS 10 verifies the integrity of the data bus using a handshake method between two vehicle modules which are still active when the vehicle is in a key-off condition. Two vehicle modules that are used, are still in an active mode to minimize the current draw from the battery. Thus, the battery size can be kept to a minimum.

If the SAE J1850 is inactive, the APM 16 wakes up in 8 msec, step 66. As the APM 16 wakes up, it transmits the $5C-2A-02-00-CRC message to the Body Control Module (BCM), step 68. The $5C-2A-02-00-CRC is a motion status message used by the memory system, that is indicative of whether or not the APM 16 is manually performing an adjustment. In the presently preferred embodiment, BCM is used for the handshake method. However, it would be understood that any vehicle module that is still active in key-off condition could also be used.

The BCM has been in an inactive mode until it receives $5C-2A-02-00-CRC bus message from the APM 16. As shown in step 70, when the BCM receives a signal, the BCM is activated sending $5B bus message back to the APM 16 in 60 msec. Within 25 msec., the APM 16 must receive the $5B bus message in order to verify the integrity of the SAE J1850 32 bus.

As indicated in Tables 2 and 3, the $5B bus message is indicative of the ignition status. If APM 16 receives $5B from the BCM within 60 msec., APM 16 confirms that the SAE J1850 data bus 32 is capable of receiving and transmitting data signals. If the APM 16 does not receive the $5B bus message within 90 msec. after transmitting $5C bus message, then the APM 16 returns to sleep mode and tries again with the next activation of a manual switch.

$5B bus message indicates whether the ignition state is in RUN mode. In RUN mode, the APM 16 retrieves the SAE J1850 bus 32. The APM 16 logs a fault when the APM 16 does not receive a needed bus message within a maximum period of 5 seconds. Therefore, by monitoring the ignition status, the APM 16 determines which lockout conditions are relevant before adjusting the pedal assemblies 12 and 14.

FIG. 5 is a table 90 depicting the bus messages and transmission rates 92 for different ignition states. The different ignition states are accessory-mode 94, lock-mode 96, unlock-mode 98, run-mode 100 and start-mode 102. All of the bus messages are available when the ignition state is in run-mode 100. The PRNDL bus message is available when the ignition state is in unlock-mode 98. The APMS 10 can adjust the pedal assemblies 12 and 14 if the input signal comes from the memory 26 during unlock mode 98. Also, $37 message is not available when the ignition state is in start-mode 102. This is because $37 message is generated by the transmission module such as EATX that is asleep in the ignition start mode. Bus message $37 is, thus, generated only when the associated transmission module is awake.

FIG. 6 shows fault lockout conditions 110 to disable the APM 16 when at least one of the bus messages $5B 112, $10 114, $35116, $37 118 and $54 120 is missing. Comments 126 show where the log fault is located when one or more bus messages are missing. Whether to disable the APM 16 when at least one of the bus messages is missing also depends on whether the input signal comes from the manual switch 28 or the memory 26. Manual pedal adjustment 122 and memory recall adjustment 124 columns show if the pedal assemblies 12 and 14 are adjusted when various faults are present.

The APMS 10 controls the movement of the brake 12 and accelerator 14 pedal assemblies through a full range of adjustment as selected by the vehicle occupant. The pedal assemblies 12 and 14 can be adjusted in the range of 80 mm from the nominal position (fully forward position) by the use of a manual switch. The pedal assembly 12 and 14 adjust at a speed of 11.5 mm/sec under nominal conditions of 13.5 volts and 25° C. The APMS 10 has at least two positions stored in memory 26 for the purpose of the vehicle occupant's personalization.

Those skilled in the art can now appreciate from the foregoing description that the broad teachings of the present invention can be implemented in a variety of ways. Therefore, while this invention has been described in connection with particular examples thereof, the true scope of the invention should not be so limited since other modifications will become apparent to the skilled practitioner upon a study of the drawings, specifications and following claims.

What is claimed is:

1. A system of verifying the integrity of a data bus for a motor vehicle comprising:
a first module for acknowledging a manual input signal initiated by the motor vehicle occupant, the first module being activated upon receiving the input signal, and transmitting a triggering signal to a second module;
the second module for communicating bi-directionally with the first module, the second module being activated upon receiving the triggering signal from the first module, and transmitting the signal back to the first module; and
a data bus for providing a bi-directional communication between first and second modules,
wherein the integrity of data bus is verified by transferring a signal between first and second modules over the data bus within a predetermined time period.

2. The system of claim 1 wherein the first module has active and inactive modes when the motor vehicle is in key-off condition.

3. The system of claim 1 wherein the second module has active and inactive modes when the motor vehicle is in key-off condition.

4. The system of claim 1, wherein the first module is an adjustable pedal module of the motor vehicle.

5. The system of claim 1, wherein the second module is a body control module of the motor vehicle.

6. The system of claim 1, wherein the first module is in inactive mode when the first module is not in communication with other vehicle modules.

7. The system of claim 1, wherein the second module is in inactive mode when it is not in communication with the first module.

8. The system of claim 1 wherein the predetermined time period is ninety milliseconds.

9. The system of claim 1 wherein the data bus is a SAE J1850 data bus.

10. A system of verifying the integrity of a data bus for a motor vehicle comprising:
a first module for acknowledging a manual input signal initiated by the motor vehicle occupant, wherein the first module has active and inactive modes, the first module being in inactive mode during its normal condition, and being activated upon receiving the input signal, and transmitting a triggering signal to a second module;
the second module for communicating bi-directionally with the first module, wherein the second module has active and inactive modes, the second module being in inactive mode during the normal condition, and being activated upon receiving the triggering signal from the first module, and transmitting the signal back to the first module; and
a data bus for providing a bi-directional communication between first and second modules,
wherein the integrity of data bus is verified by transferring a signal between first and second modules over the data bus within a predetermined time period.

11. The system of claim 10, wherein the first module is an adjustable pedal module of the motor vehicle.

12. The system of claim 10, wherein the second module is a body control module of the motor vehicle.

13. The system of claim 1 wherein the predetermined time period is ninety milliseconds.

14. The system of claim 1 wherein the data bus is a SAE J1850 data bus.

15. A method of verifying the integrity of a data bus for a motor vehicle comprising the steps of:
acknowledging a manual input signal by a first module of the motor vehicle, the manual input signal being initiated by a motor vehicle occupant;
activating the first module subsequently upon receiving the manual input signal, wherein the first module has been in inactive mode;
transmitting a triggering signal from the first module over the data bus to a second module that is in inactive mode;
activating the second module upon acknowledgment of the triggering signal, the second module re-transmitting the signal back over the data bus to the first module within a predetermined time period; and
receiving the signal transmitted by the second module by the data bus.

16. The method of claim 15 wherein the first module is an adjustable pedal module of the motor vehicle.

17. The method of claim 15 wherein the second module is a body control module of the motor vehicle.

18. The method of claim 15 wherein the predetermined time period is ninety milliseconds.

19. The method of claim 15 wherein the data bus is a SAE J1850 data bus.

20. A system of verifying the integrity of a J1850 data bus for a motor vehicle comprising:
an adjustable pedal module for acknowledging a manual input signal initiated by the motor vehicle occupant, wherein the adjustable pedal module has active and inactive modes, the adjustable pedal module being in inactive mode during its normal condition, and being activated upon receiving the input signal, and transmitting a triggering signal to a body control module;
the body control module for communicating bi-directionally with the adjustable pedal module, wherein the body control module has active and inactive modes, the body control module being in inactive mode during the normal condition, and being activated upon receiving the triggering signal from the adjustable pedal module, and transmitting it back to the adjustable pedal module; and
the J1850 data bus for providing bi-directional communication between the adjustable pedal module and the body control module,
wherein the integrity of the J1850 data bus is verified by transferring a signal between the adjustable pedal module and the body control module over the data bus within ninety milliseconds.
